(19) United States
(12) Patent Application Publication
(10) Pub. No.: US 2006/0258244 A1
(43) Pub. Date: Nov. 16, 2006

(54) Structural unit in the form of a cavity-formed part, and use thereof

(76) Inventors: Oliver Salzmann, Willich (DE); Guido Franzke, Sassenberg (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/430,318

(22) Filed: May 9, 2006

(30) Foreign Application Priority Data
May 10, 2005 (DE) 20 2005 007 647.3
Nov. 10, 2005 (DE) 10 2005 054 063.5
Dec. 23, 2005 (DE) 10 2005 062 351.4

(51) Int. Cl. B32B 5/24; B32B 5/18

(52) U.S. Cl. 442/221

(57) ABSTRACT

The present invention relates to a structural unit (1) made of at least two formed parts (2a, 2b) which fashion or form at least one cavity (4), at least the first formed part (2a) having a multilayered structure (5a) having a flat, in particular textile, material (6a) associated to a support layer (3a), and the flat material (6a) being laminated to the support layer (3a) on the side of the support layer (3a) facing away from the cavity (4), and also to furnishing articles which have the structural unit (1), and to a process for production of the structural unit (1).

### CROSS REFERENCES TO RELATED APPLICATIONS

The present application claims priority to German Patent Application Serial No. DE 20 2005 007 647.3, filed May 10, 2005; German Patent Application Serial No. DE 10 2005 054 063.5, filed Nov. 10, 2005; and German Patent Application Serial No. DE 10 2005 062 351.4, filed Dec. 23, 2005, all of which are hereby incorporated by reference in their entirety.

### BACKGROUND OF THE INVENTION

The present invention relates to a structural unit in the form of a cavity-formed part and also to use thereof, in particular for production of furnishing articles, in particular furniture, preferably seating furniture, decorative elements, cavity channels and the like, and also the articles of the abovementioned type produced therewith as such. Finally, the present invention relates to a process for production of such a structural unit.

Three-dimensional cavity-formed parts are known from the prior art which are produced from sheet-type starting materials, the sheet-type starting materials generally being single-layer sheets or films of a thermoplastic material which, for example, can be formed by thermoforming. For the production of these simple hollow formed parts in particular consisting of single-layer formed parts, in the prior art what is termed the twin-sheet process, also called synonymously twin-sheet forming or twin-sheet thermoforming, is used, which is a special process type of thermoforming (heat forming). In the context of the twin-sheet process, two sheet-type, generally thermoplastic, starting materials having a single-layer structure are first heated to temperatures above their softening point and subsequently conducted in a parallel arrangement into a two-part mould, then converted into formed parts by pressure and vacuum imposition, and finally joined to form a hollow formed body in which the structures formed from the sheet-type starting materials are firmly joined together and enclose a cavity. In this manner simple technical articles are produced in the prior art, for example cavity profile parts, water containers or petrol tanks. Since in the prior art it is only envisaged, as mentioned above, to process single-layer thermoplastic materials in this manner, it is not possible, for example, to produce products having particular properties, such as special surface properties.

Such single-layer cavity formed parts are thus not suitable for use, e.g., in furniture, in which, in addition to a certain structural strength, precisely also special surface properties (e.g. optical or haptic properties) and anatomical or ergonomic properties (seating comfort in the case of seating furniture) play an important part.

In this context it is provided in the prior art with respect to the production of multilayered formed parts containing a thermoplastic component or layer that a formable material which is generally sheet-shaped, after conversion into a three-dimensional form or structure, is coated with a further layer, for example a flat textile or the like, or this further layer is applied to the already finished formed part and permanently bonded thereto, for example by means of an adhesive. A disadvantage in this case, however, is that the flat material is only applied after the forming, because this makes the adhesion difficult, and that the high number of process steps is more labor intensive and costly. In particular, it is frequently impossible to bond flat textile material over the surface to the formed material since, in particular in the region of large deformations (e.g. in the case of large bends, indentations or projections and the like), large strain or compression of the flat textile material occurs, which can frequently lead to detachment or delamination of the flat material. In addition, with respect to the subsequent application of a layer to the three-dimensional structure, frequently unwanted crease formation occurs. A further disadvantage in this process is considered to be that owing to the subsequent fixing of the flat textile material to the three-dimensional structure, a non-uniform strain of the flat textile material can result, which leads to a non-uniform surface profile. Finally, pores or non-uniform return forces resulting from the subsequent, occasional non-uniform, “stretching” of the flat textile material onto the support structure can lead to subsequent deformation of the formed part.

Against this technical background, the object of the present invention is then to provide a structural unit which at least in part avoids or at least ameliorates the above-described disadvantages of the prior art. In particular, a cavity-containing structural unit is to be provided which comprises at least one flat, in particular textile, material on at least one support and which is to be suitable in particular for use for furnishing articles, such as furniture and the like, i.e. has both ergonomically and optically improved properties. In this case, with respect to the structural unit, large bends, indentations and projections and the like are to be able to be implemented without delamination or fold formation occurring with respect to the individual layers of the structural unit. Finally, the resultant formed part is to be firstly self-supporting and dimensionally stable to a great extent and, secondly, have yielding or reversibly deformable regions so that it is suitable, in particular, for use in furniture, for example seating furniture.

To achieve the above-described object, the present invention proposes a structural unit according to what is disclosed and claimed herein. Further advantageous embodiments are subject-matter of the respective subclaims.

In addition, the present invention relates to the use of the inventive structural unit for production of furnishing articles, in particular furniture, preferably seating furniture, decorative elements, cavity channels and the like, and also to furnishing articles, in particular furniture, preferably seating furniture, decorative elements, cavity channels and the like.

Finally, the present invention relates to a process for production of the inventive structural unit as defined in the respective process claims. Further advantageous embodiments of the inventive process are subject-matter of the process subclaims.

A first subject-matter of the present invention is thus a structural unit which is suitable, in particular, for the production of furniture, decorative elements, cavity channels and the like and which comprises a first formed part having a support layer and a second formed part having a support layer, the first formed part and the second formed part fashioning (i.e. forming) at least one cavity. The inventive structural unit is distinguished, in particular, in that the first formed part has a multilayered structure, the first formed part having a flat, in particular textile, material associated to the support layer. In this case it is provided according to the invention that the flat material is laminated to the support layer on the side of the support layer facing away from the cavity. By this means it is possible, in particular, to provide an inventive structural unit which has particular material properties, such as special surface properties and reversible deformability, so that the inventive structural unit is suitable in particular for the production of furnishing articles, in particular furniture, preferably seating furniture, decorative elements, cavity channels and the like. In the context of the present invention it is possible, with respect to the structural unit of the invention, to achieve large bends or deformations, as a result of which individual shapes or structures can be provided adapted to the respective requirements, for example anatomical shaping with simultaneously high load-bearing capacity in relation to seating furniture.

As can the first formed part, so can also the second formed part have a multilayered structure having a preferably thermoplastic support layer and a flat, in particular textile, material associated to the support layer, the flat material of the second formed part likewise being laminated to the support layer on the side of the support layer facing away from the cavity, so that a uniform surface quality or structure can be realized for the entire inventive structural unit.

As further extensively described hereinafter, the formed parts forming the inventive structural unit are not limited to an above-described two-layer structure. Rather, it is equally possible that a support is additionally provided, the optional support being bonded to the support layer, preferably on the side facing the cavity, so that to some extent a “sandwich structure” results, in which the support layer so to speak forms the core layer of the layered or composite material. As a result, particularly dimensionally stable structures or shapes can be achieved, which can also withstand a high force load. As a result of a targeted combination, for example, of a two-layered formed part with a deformable support layer and a three-layered formed part with a solid support, the abovementioned properties, purpose-matched formability and high load-bearing capacity, can be combined with one another.

An underlying concept of the present invention is to be considered to be, in particular, that as starting materials for the inventive structural unit, use is made of pre-fabricated multilayer sheet-type material parts containing all components or layers, which parts are fashioned/designed in particular as a composite which can be processed, preferably in a special forming process, particularly preferably in what is termed a twin-sheet process, to give formed parts which are bonded to one another to obtain the inventive structural unit. In other words the present invention is distinguished in particular in that already before, or during, the forming step a stable composite material having layers which are permanently bonded to one another over the surface is provided, so that subsequent application of layers after the forming process, in particular after the twin-sheet process, can be completely omitted. As a result, it is made possible according to the invention to furnish the inventive structural unit with particularly highly and differently formed regions without, for example, the flat material applied to the support layer delaminating, or without the formation of folds, bubbles or the like. A further underlying concept of the present invention is in addition to be considered to make use of the twin-sheet process known from the prior art for the production of multilayered structural units firstly by targeted selection of the starting materials, and also secondly by a special adaptation of the process parameters. In this case, by means of the inventive process, in a simple manner finished structural units can be provided inexpensively in terms of labor and costs which meet the high requirements in the furniture industry sector, i.e. high load-bearing capacity, anatomical adaptation and also individual structuring with attractive optical and haptic properties.

According to the invention the term “three-dimensional” (e.g. three-dimensional shape or structure with respect to the inventive structural unit or the formed part in particular) is taken to mean a structure such as has regions which are shaped so as to deviate from the flat or planar structure, or spatial regions which include, for example, indentations or projections, recesses, bulges, bends and the like.

In addition, according to the invention the term “sheet-type” (e.g. sheet-type material part) is taken to mean an at least essentially flat or planar shape or structure, for example of the material part used for the inventive structural unit, the thickness of the material part being at least essentially constant over its surface. Where it is desired specific to the application, the individual layers on an area basis, however, can also have different thicknesses, for example to achieve further optimized anatomical shape in the case of seating furniture.

The expression “associated” (e.g. a flat material associated to the support layer) is to be taken to mean, according to the invention, that firstly the possibility exists that the flat material is laminated immediately, i.e. directly, to the support layer, but secondly this term can equally also comprise indirect association of the flat material with respect to the support layer in which, for example, at least one further intermediate layer, for example a further support layer deviating from the first support layer, is arranged between the flat material and the support layer.

In addition, the term “dimensionally stable” (e.g. dimensionally stable structural unit or formed part) is to be taken to mean according to the invention that the inventive structural unit in the respective use, for example in the context of the production of seating furniture, can withstand the resultant loads or is able to absorb these, reversible deformation being covered by this definition.

In the context of the present invention, the term “formable” (e.g. formable support or formable material part) is to be taken to mean that the support or the material part can be at least essentially irreversibly converted into another shape or structure, retaining the mass of the layered association.

In this context the term “thermoformable” (e.g. thermoformable material part) is to be taken to mean that, for example, the material part used for production of the formed parts or of the inventive structural unit can be formed with heating to a temperature range above the softening point, in particular by heat forming. In the context of the present invention, as heat-forming process, use is made of in particular what is termed the twin-sheet process.

Finally, the term “laminating” (e.g. laminating the flat material to the support layer) is to be taken to mean an in particular flat bonding or glueing of the respective layers of the inventive structural unit, in which case the individual layers can be bonded, for example by means of processes well known to those skilled in the art, in particular film-coating processes, generally by means of suitable laminating or film-coating agents, such as adhesives, hot-melt adhesives, hot-melt adhesive webs and the like. In this context, the flat bonding or laminating or film-coating of the individual layers is preferably to take place over the whole surface, i.e. the film-coating agent is preferably applied continuously. However, discontinuous bonding is also equally possible, for example by means of point-like or raster-like application of the adhesive. According to a particular embodiment, the respective layers of the inventive structural unit can be bonded to one another by flame bonding processes known per se to those skilled in the art, in which case it should be ensured, in particular, that at least one layer has thermally adhesive properties.

Finally, the term “cavity” (e.g. a cavity fashioned/formed by the first formed part and the second formed part) is to be taken to mean that the first formed part and the second formed part of the inventive structural unit are arranged or bonded in such a manner that they at least essentially completely enclose the resultant cavity. In this respect it can be provided according to the invention that the cavity is completely enclosed by the formed parts, i.e. without breakthroughs and the like. However, it is equally within the context of the present invention when the cavity is only partially enclosed by the formed parts. Thus it is possible, for example, that in the region of the connection points of the formed parts channels, breakthroughs or the like are fashioned/formed, so that the cavity is to some extent provided with orifices. Through these orifices, for example, it is possible, as described in detail hereinafter, for pressurization during production of the inventive structural unit, or filling with fillings during or after the production of the inventive structural unit to be carried out. The term cavity thus also comprises a (hollow) space filled up or partially filled with fillings. In addition the number of cavities fashioned/formed by the formed parts is unlimited. For instance, it is possible that the formed parts fashion (i.e. form) a multiplicity of cavities, for example one, two, three, four etc. cavities.

Further advantages, features, properties and aspects of the present invention are given by the following description of preferred embodiments with reference to the figures.

### BRIEF SUMMARY OF THE INVENTION

The present invention relates to a structural unit (1) made of at least two formed parts (2a, 2b) which fashion or form at least one cavity (4), at least the first formed part (2a) having a multilayered structure (5a) having a flat, in particular textile, material (6a) associated to a support layer (3a), and the flat material (6a) being laminated to the support layer (3a) on the side of the support layer (3a) facing away from the cavity (4), and also to furnishing articles which have the structural unit (1), and to a process for production of the structural unit (1).

One object of the present invention is to provide an improved structural unit suitable for use in furnishing articles.

Related objects and advantages of the present invention will be apparent from the following description.

### BRIEF DESCRIPTION OF THE SEVERAL VIEWS OF THE DRAWINGS

FIG. 1 shows a diagrammatic cross section of a structural unit according to one embodiment of the present invention.

FIG. 1A shows a diagrammatic cross section of a formed part according to the present invention having a two-layer structure.

FIG. 1B shows a diagrammatic cross section of a formed part according to an alternative embodiment of the present invention having a three-layer structure.

FIG. 1C shows a diagrammatic cross section of another formed part according to the present invention having a two-layer structure.

FIG. 1D shows a diagrammatic cross section of another formed part according to an alternative embodiment of the present invention having a three-layer structure.

FIGS. 2A-2G show diagrammatic representations of a process sequence according to the present invention.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

In the figures the same reference signs are used for identical or similar parts, corresponding properties and advantages being achieved, even when repeated description is omitted for the sake of simplification.

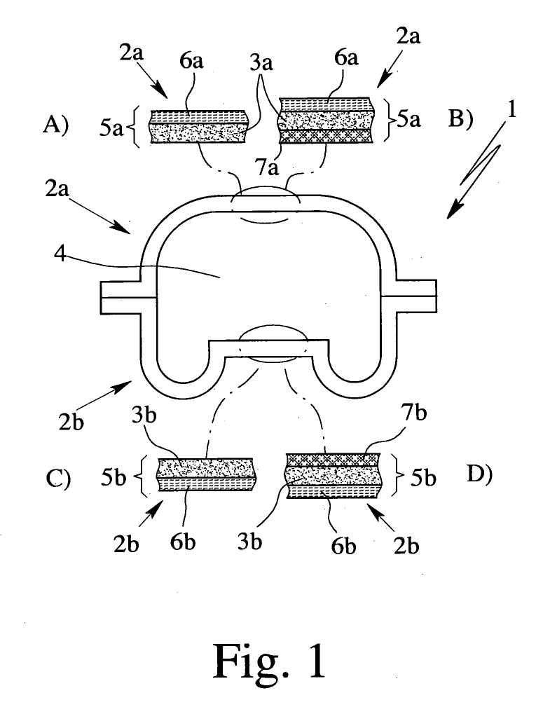

FIG. 1 shows an inventive structural unit 1 which comprises a first formed part 2a having a support layer 3a and a second formed part 2b having a support layer 3b. According to the invention the first formed part 2a and the second formed part 2b fashion or form at least one cavity 4. As shown in FIG. 1, the first formed part 2a has a multilayered structure 5a, the first formed part 2a having a flat, in particular textile, material 6a associated to the support layer 3a. As further indicated in FIG. 1, the flat material 6a is laminated to the support layer 3a on the side of the support layer 3a facing away from the cavity 4. In other words, it is provided according to the invention that the flat material 6a is to some extent arranged on the outside of the inventive structural unit 1 and thus in the service state of the inventive structural unit 1 forms its outwards-directed surface.

FIG. 1 thus shows an inventive structural unit 1 which is formed from two formed parts 2a, 2b, which are bonded to one another firmly or permanently in such a manner that they fashion a cavity 4 of the type defined above. Consequently the inventive structural unit 1 is to an extent a hollow body.

As further indicated in FIG. 1, the inventive structural unit is distinguished in that it has a three-dimensional structure according to the abovementioned definition, in which case, by means of a specifically adjustable and purpose-directed embodiment of the three-dimensional shape or structure, a multiplicity of various hollow bodies can be realized, so that the inventive structural unit 1 is suitable for numerous uses, for example as seat and/or back part of a piece of seating furniture.

To obtain the three-dimensional structure of the inventive structural unit 1 it is possible to provide, as indicated in FIG. 1, that at least one of the formed parts 2a or 2b has a three-dimensional shape or structure. According to the invention, preferably not only the first formed part 2a but also the second formed part 2b has a three-dimensional shape or structure. However, it is also equally possible that the first formed part 2a or the second formed part 2b has a sheet-type shape or structure in the abovementioned sense.

In addition, it is preferred according to the invention, as FIG. 1 further shows, that the formed parts 2a, 2b are bonded to one another in particular in sections. According to the invention it is preferred that, against the background of fashioning a cavity, the formed parts 2a, 2b are bonded to one another in a ridged manner (for example at their rim regions), in which case it is equally possible according to the invention to bond the formed parts 2a, 2b to one another in regions different from the rim regions, such as for example the central regions of the formed parts 2a, 2b, in particular in a ridged manner, as a result of which a plurality of cavities can be achieved. The in particular ridge-type bonding can equally have interruptions or throughways and/or channels to enable connection of the cavity 4 to the outer environment of the inventive structural unit 1 or if appropriate to join a plurality of cavities 4 to one another.

The formed parts 2a, 2b can be bonded, for example, by laminating, film-coating or glueing, in which case use can be made of the adhesives mentioned above under the definition “laminating”. In addition, for bonding the formed parts 2a, 2b, in addition, use can be made of plastic dispersions known per se to those skilled in the art, but also reactive adhesives, such as, in particular, polyurethane-based single- or two-component systems. It is also equally possible that at least one of the formed parts 2a, 2b is fashioned to be thermally adhesive, so that in the case of appropriate heating of the formed parts 2a, 2b, permanent bonding of the two formed parts 2a, 2b results. Generally, it is provided according to the invention that the formed parts 2a, 2b are bonded during their production or during the production of the inventive structural unit 1, in particular in the context of the twin-sheet process. According to the invention it is preferably provided that the bonding or glueing of the formed parts 2a, 2b is performed on the side of the formed part 2a facing away from the flat material 6a and also on the side of the formed part 2b facing away from a flat textile material 6b.

As far as the inventive structural unit 1 is concerned as such, it can also have more than two formed parts 2a, 2b. For instance it is in the context of the present invention when the inventive structural unit 1 has three, four, five or more formed parts which are arranged in the abovementioned manner to give the inventive structural unit 1.

As far as the first formed part 2a of the inventive structural unit 1 is concerned, FIG. 1A shows by way of example an inventively preferred embodiment, according to which the formed part 2a represents a composite or a layered material of two layers, that is to say the support layer 3a firstly and the flat material 6a secondly, formed as one piece. The present invention, however, is not in any way restricted to this embodiment.

For instance, FIG. 1B shows an alternative inventive embodiment, according to which the first formed part 2a additionally has an in particular thermoplastic support 7a. The support 7a can be bonded to the support layer 3a, in particular bonded in a two-dimensional manner, preferably on the side facing the cavity 4. According to this embodiment the support layer 3a is preferably a foam layer described hereinafter, while the support 7a, as described hereinafter, is a non-foamed solid thermoplastic support. According to the embodiment of FIG. 1B, therefore, the flat material 6a is laminated in the above-described manner to the support layer 3a, and the support layer 3a is in turn laminated to the support 7a. Alternatively, the support 7a can be bonded to the intermediate layer 3a by flaming. Equally it is possible that the flat material 6a and/or the support layer 3a and/or the support 7a is or are fashioned to be thermally adhesive, so that a permanent bond can result via appropriate heating and joining of the respective layers. According to the embodiment according to FIG. 1B a three-layer material thus results which is equally fashioned in the manner of a composite material, like the formed part 2a described in FIG. 1A fashioned as a two-layer material. According to the embodiment described in FIG. 1B, the support 7a, with respect to the inventive structural unit 1, is to an extent arranged internally, i.e. on the side facing the cavity 4, or on the side facing away from the flat textile material 6a.

As far as the second formed part 2b which is used for the inventive structural unit 1 is concerned, this can also have a multilayered structure 5b, as FIG. 1C and also FIG. 1D show, which consists, for example, of a support layer 3b and a flat textile material 6b associated to the support layer 3b (FIG. 1C).

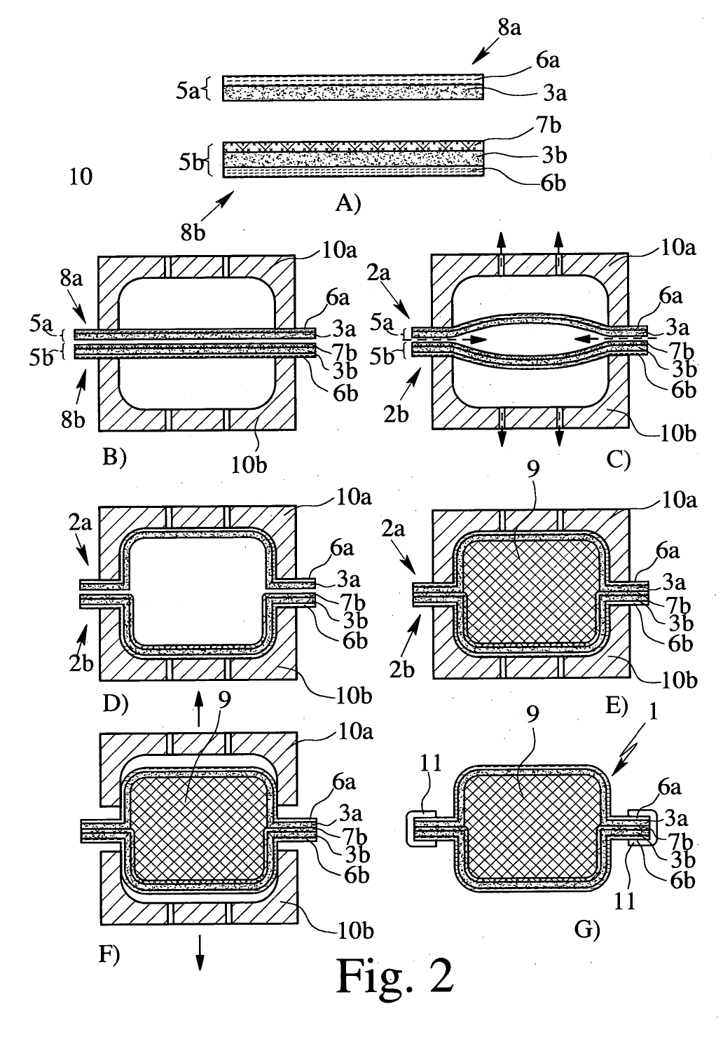

The second formed part 2b which is used for the inventive structural unit 1 can also, as can be inferred from FIG. 2C, be fashioned as a two-layer material, in which case the second formed part 2b then has a flat, in particular textile, material 6b associated to the support layer 3b. Also in relation to the second formed part 2b, the flat material 6b is laminated to the support layer 3b on the side of the support layer 3b facing away from the cavity 4, so that the flat material 6b is equally, as is the flat material 6a of the first formed part 2a, to some extent arranged externally with respect to the inventive structural unit 1. FIG. 2D shows an alternative inventive embodiment, according to which the second formed part 2b has an in particular thermoplastic support 7b and is thus fashioned as a three-layer material. In this case the support 7b is bonded to the support layer 3b, in particular bonded in a two-dimensional manner, preferably on the side facing the cavity 4, and thus to an extent internally with respect to the inventive structural unit 1. For further statements relating to the support layer 3b and the flat material 6b, and also the support 7b of the second formed part 2b, reference can be made to the above statements relating to the first formed part 2a, which equally apply here.

In other words, the present invention, as shown in FIG. 1, relates to a structural unit 1 which has at least two formed parts 2a, 2b each having a multilayered structure 5a, 5b, with at least one component or layer of the first formed part 2a and/or the second formed part 2b being a formable, in particular thermoformable, layer, which consists of a thermoplastic material. If required in an application-related manner, one of the formed parts 2a or 2b can be of single-layered fashion, with the corresponding formed part then having, for example, only the flat material 6a, 6b or the support layer 3a or 3b or the support 7a, 7b. Equally, it is possible according to the invention that the support layer 3a, 3b comprises a plurality of individual layers which can consist, for example, of different foam materials, so that a multilayered structure 5a, 5b having more than three layers can also result.

A special feature of the present invention is to be considered in that the inventive structural unit 1 consists of formed parts 2a and 2b which in turn result from sheet-type, formable, in particular thermoformable, material parts 8a and 8b respectively, as shown in FIG. 2A. In this respect the sheet-type material parts 8a and 8b acting to an extent as starting materials for the inventive structural unit 1 already have the same layered structure as the resultant formed parts 2a and 2b respectively. In other words, according to the invention, prefashioned or prefabricated material parts 8a and 8b are used, which already have all components or layers of the finished end product (i.e. the inventive structural unit 1 resulting from the bonded formed parts 2a and 2b) and which, in this already prefabricated fashioning are formable into the formed parts 2a and 2b for production of the inventive finished structural unit 1. Thus, after finishing of the end product 1, for example, subsequent coating or impingement steps are omitted which, as described above, frequently do not lead to satisfactory results. In particular, by this means, in relation to the inventive structural unit 1, large deformations or bends can be achieved, so that a multiplicity of various structures and shapes can be achieved, which can be specifically adapted to the respective profile of requirements.

As far as the dimensioning of the layers is concerned, the flat material 6a, 6b and/or the support layer 3a, 3b and/or the support 7a, 7b can have the same dimensions in area terms, so that the layers to an extent are arranged congruently in the material part 8a, 8b. It can be provided that the rim regions of the layers 6a, 6b; 3a, 3b; 7a, 7b are not laminated, so that the rim regions of the flat material 6a, 6b and/or of the support layer 3a, 3b can to an extent be folded down or up from the support 7a, 7b. According to a further inventive embodiment, the flat material 6a, 6b and/or the support layer 3a, 3b is or are dimensioned smaller in area terms than the support 7a, 7b, so that the support 7a, 7b then extends to an extent over at least one edge of the flat material 6a, 6b and/or the support 7a, 7b. As described hereinafter, such an inventive material part 8a, 8b can be formed in a special manner.

The optional additional support 7a or 7b is preferably a thermoplastic which is hard at service temperature, in particular at room temperature (25° C.), and atmospheric pressure. Thus the support 7a or 7b, at room temperature (25° C.) and atmospheric pressure, should be at least dimensionally stable and self-supporting. In particular, the thermoplastic support 7a or 7b should be such that after the forming process for producing the inventive structural unit 1 has been carried out the return forces possibly occurring due to the flat material 6a, 6b or the support layer 3a, 3b lead at least essentially to no shape change of the inventive structural unit 1 or of the formed parts 2a, 2b.

The support 7a, 7b is preferably fashioned to be nonporous or non-foamed. In other words, the support 7a, 7b according to an inventively particularly preferred embodiment is solid or cavity-free as such. This achieves, if desired, a particularly good dimensional stability or mechanical stability of the inventive structural unit 1 or of the formed parts 2a, 2b. Equally, the nonporous structure of the support 7a or 7b enables the resulting material parts 8a and 8b respectively to be formed readily, for example by means of thermoforming processes, such as the twin-sheet process, to give the three-dimensional formed parts 2a, 2b or the inventive structural unit 1.

In the context of the present invention, the material of the support 7a or 7b can be selected from polymers or copolymers. In this respect, preferably polyolefins, vinyl polymers, polyamides, polyesters, polycarbonates and polyurethanes come into consideration. According to an inventively preferred embodiment, the material of the support 7a or 7b comprises polyolefins, in particular polyethylene or polypropylene, particularly preferably polypropylene copolymers, or else acrylonitrile/butadiene/styrene copolymers (ABS copolymers). For further details with respect to thermoplastics, reference can be made to Römpp Chemielexikon [Römpp's Chemistry Lexicon], 10th edition, Volume 6, 1999, Georg Thieme Verlag, Stuttgart/New York, pages 4505/4506, headword: “Thermoplastics”, the entire disclosure including the literature references cited there being incorporated hereby by reference.

Equally, in the context of the present invention, what are termed thermoplastic elastomers can also be used for the support 7a or 7b, which have a combination of service properties of elastomers and the processing properties of thermoplastics. For further details in this respect, equally reference can be made to Römpp Chemiel-exikon [Römpp's Chemistry Lexicon], 10th edition, Volume 6, 1999, Georg Thieme Verlag, Stuttgart/New York, pages 4506/4507, headword: “Thermoplastic elastomers”, the entire disclosure including the literature references cited there being incorporated hereby by reference.

According to the invention, for the optional support 7a or 7b, particularly preferably use is made of those materials or thermoplastics which have a yield stress as specified in ISO 527 of 5 to 10 N/mm², preferably 10 to 45 N/mm², more preferably 15 to 40 N/mm², particularly preferably 20 to 35 N/mm². Equally, the material of the support 7a or 7b should have a yield strain as specified in ISO 527 of less than 20%, preferably less than 16%, more preferably less than 12%. The material of the support 7a or 7b should, in addition, have a tear strength as specified in ISO 527 of at least 15 N/mm², preferably at least 20 N/mm², more preferably at least 25 N/mm², and/or an elongation at break as specified in ISO 527 of 5 to 700% and a modulus of elasticity as measured in the 4-point bending test as specified in ISO 178 of 500 to 2200 N/mm², preferably 700 to 2100 N/mm², more preferably 900 to 1900 N/mm².

As far as the material of the optional support 7a or 7b is further concerned, this can be impact resistant without fracture at 23° C. (impact strength according to Charpy as specified in EN ISO 179/leU) or have an impact strength according to Charpy as specified in EN ISO 179/leU at −30° C. of at least 40 kJ/m², preferably at least 50 kJ/m², more preferably at least 60 kJ/m², particularly preferably at least 70 kJ/m². In addition, the material of the support 7a or 7b can have a notched impact strength as specified in EN ISO 179/leA at 23° C. of at least 15 kJ/m², preferably at least 25 kJ/m², more preferably at least 35 kJ/m². In addition the material of the support 7a or 7b can have a notched impact strength as specified in EN ISO 179/leA at −30° C. of at least 1 kJ/m², preferably at least 2 kJ/m², more preferably at least 3 kJ/m², and in addition have a ball indentation hardness (H358/30) as specified in EN ISO 2039-1 of at least 50 N/mm², preferably at least 60 N/mm² more preferably at least 70 N/mm². Finally, the material of the support 7a or 7b should have a density of 0.8 to 1.5 g/cm³, in particular 0.85 to 1.4 g/cm³, preferably 0.9 to 1.3 g/cm³. Finally the material of the support 7a or 7b should have a Vicat softening temperature (VST A 120 or VST B 50) as specified in ISO 306 of 80° C. to 200° C., preferably 85° C. to 180° C., more preferably 90° C. to 160° C. Suitable materials for the optional support 7a or 7b are, for example, Metzo®Plast PP/C and Metzo®Plast ABS/M from Metzeler Plastics GmbH, Jülich, Germany.

The thickness of the thermoplastic material or the support 7a, 7b can vary in a broad range. According to the invention, preferably, the optional support 7a or 7b can have a thickness of 1 mm to 20 mm, preferably 1.5 mm to 5 mm, more preferably 2 mm to 10 mm, particularly preferably 2.5 mm to 7 mm, very particularly preferably 3 mm to 5 mm. At all events, it is possible to deviate from these values in an application-related manner or owing to individual cases, for example when the formed parts 2a and 2b are to be used in the context of an inventive structural unit 1, for example for production of particularly load-bearing furniture or seating furniture, the thickness of the support then being able to markedly exceed 15 mm.

As far as the abovementioned statements are concerned with respect to the optional support 7a or 7b, the information relates in each case to the support 7a of the first formed part 2a or the support 7b of the second formed part 2b, the respective supports 7a and 7b being able to be identical or fashioned differently from one another.

As mentioned above, it can be provided in an application-specific manner or owing to an individual case that one of the formed parts 2a or 2b is of single-layer fashion and consists only of a support layer 3a, 3b or a support 7a, 7b.

In relation to the two-layered fashioning, the flat material 6a, 6b can be laminated to a support layer 3a, 3b. The support layer 3a, 3b can preferably in this case be a thermoplastic which is hard at service temperature, in particular at room temperature (25° C.) and atmospheric pressure, or at room temperature (25° C.) and atmospheric pressure is at least essentially dimensionally stable and/or at least essentially self-supporting or be fashioned to nonporous and/or nonfoamed. In this context the support layer 3a, 3b can be selected from polymers and/or copolymers from the group of polyolefins, vinyl polymers, polyamides, polyesters, polycarbonates and/or polyurethanes, preferably polyolefins, particularly preferably polypropylene copolymers or acrylonitrile/butadiene/styrene copolymers (ABS copolymers). In other words, in this case the flat material 6a or 6b without a further foam layer is to an extent laminated directly to a support layer 3a, 3b of material properties comparable to the support 7a, 7b.

In order to be able to achieve the above-described large deformations or bends with respect to the inventive structural unit 1, the flat material 6a or 6b should generally be extensible or flexible in order to prevent effectively premature delamination or fold formation. For this purpose, the flat material 6a or 6b can preferably be a flat textile material, and in particular a woven fabric, knits or scrim. According to an inventively particularly preferred embodiment, the flat material 6a or 6b is a woven fabric. In addition, it is, however, equally possible to use a leather or an artificial leather, for example, as flat material 6a or 6b. Equally, film-like plastics and thin-walled metal films also come into consideration as flat material 6a or 6b. In particular, the flat material 6a or 6b can be selected in such a manner that it is at least essentially lightproof.

The weight per unit area of the flat material 6a or 6b can vary in broad ranges. For instance the flat material 6a or 6b can have a weight per unit area of 25 to 600 g/m², in particular 50 to 500 g/m², preferably 100 to 400 g/m². For the abovementioned purposes of avoiding premature delamination or fold formation and for fashioning large bends or deformations with respect to the inventive structural unit 1, the flat material 6a or 6b should be reversibly extensible and/or in particular bielastic, i.e. extensible in both directions, or highly elastic. The flat material 6a or 6b can have an extensibility in at least one direction, preferably in the longitudinal and transverse directions, of at least 5%, in particular at least 10%, preferably at least 20%, in order to be able to follow the length and width changes possibly occurring on forming without tearing.

According to an inventively particularly preferred embodiment, use is made as flat material 6a or 6b of an in particular bielastic textile woven fabric which has, for example, an elasticity in the warp direction of about 35% or more and in the weft direction an elasticity of 20% or more.

For production of such a bielastic woven fabric, by way of example, and in a non-restricting manner, use can be made of special elastic twists as are described by way of example in the Applicant's own EP 0 036 948 A1, the contents of which are hereby incorporated by reference in their entirety. This relates in particular to an elastic twist in which an elastomeric thread of about 140 to 200 denier is adhesively twisted with two yarns, the thickness of each of which is about one tenth of the elastomeric thread, the yarns used being preferably OE yarns (“open-end yarns”) produced by the rotor method from polyvinyl chloride, polycyanide, polyacrylonitrile and/or wool threads. Equally, according to the invention, use can be made of a bielastic woven fabric which is described in likewise the Applicant's own DE 28 57 498 C2, the contents of which are hereby incorporated by reference in their entirety.

According to a particularly preferred embodiment, use can be made of a bielastic woven fabric which has a weight of 350 g/m² at an elasticity in the warp direction of 35% and an elasticity in the weft direction of 20%. Such a woven fabric can, based on the total weight of the woven fabric, comprise, for example, about 4.8% Elastan®, about 89.3% polyester and about 5.9% polyamide. According to the invention it is equally possible that the flat material 6a or 6b is additionally impregnated, coated or the like, in order to finish the flat material 6a or 6b in a flame-retardant manner, for example, or to increase the soil repellancy.

As far as the design of the flat material 6a of the first formed part 2a and the flat material 6b of the second formed part 2b is concerned, these can be different from one another, i.e. the first formed part 2a can have a flat material 6a different from the second formed part 2b, as a result of which, for example, inventive structural units 1 can be achieved which have different surface properties with respect to the respective formed parts 2a and 2b. According to the invention it can equally be provided that the flat material 6a of the first formed part 2a and the flat material 6b of the second formed part 2b are identical, as a result of which a uniform surface quality results.

According to the invention the flat material 6a or 6b can be laminated to the support layer 3a or 3b or to the support 7a or 7b by means of a laminating and/or film-coating agent, in particular by means of an adhesive. According to the invention, preferably the adhesive is a hot-melt adhesive or a hot-melt adhesive web. Adhesives which come into consideration are in addition plastic dispersions which are known as such to those skilled in the art, but also reactive adhesives, for example in particular polyurethane-based single- or two-component systems. Generally, the adhesive is applied two-dimensionally, so that, for example, continuous adhesion, in particular as defined above, results. Equally, in the context of the present invention, such a flat bonding or lamination is also present in which the laminating or film-coating agent is applied in point-like or point-raster-like form or discontinuously.

As described above, it is provided according to the invention that the flat material 6a or 6b is preferably applied to a support layer 3a, preferably laminated to it. For this purpose, the support layer 3a or 3b can be an in particular thermoplastic or in particular thermoplastically deformable foam, preferably based on polyolefins or polyurethanes, foams based on polyolefins being preferred according to the invention. Equally, according to the invention, use can also be made of a polyethylene foam crosslinkable by peroxide. By special selection of the foam, the flat material 6a or 6b is in a certain manner supported, so that the inventive structural unit 1 has a certain elastic and reversible compressibility and deformability under load. As far as the foam is concerned, this can equally be plastically deformable, in particular thermoformable or thermoplastic, in which case the softening temperature should be selected in such a manner that the foam, on forming the material part 8a or 8b to give the formed part 2a or 2b to obtain the inventive structural unit 1, is not destroyed or the foam is not too highly compressed. The foam should at least be of a quality such that on account of its elasticity or deformability, using the sheet-type material part 8a, 8b, it can be brought into the shape desired for the inventive structural unit 1.

The support layer 3a or 3b, in particular the foam layer, can according to the invention be a closed-pore or closed-cell foam which generally has a lower compressibility than open-pore foams and on use of the inventive structural unit 1 has an optimum elastic and reversible compressibility under load. For example, on use in seating furniture, the foam is compressed under the stress of a load (“sitting”), so that owing to good fitting to the user a pleasant and comfortable seat feeling results, while after load (“standing”) the foam readopts its original thickness.

The support layer 3a or 3b, in particular the foam layer, can have a thickness of 1 mm to 50 mm, in particular 2 mm to 40 mm, preferably 3 mm to 30 mm, more preferably 4 mm to 25 mm, particularly preferably 5 mm to 20 mm, in which case the thickness, depending on the desired field of use, can vary in broad ranges and if appropriate can deviate from the stated ranges.

As far as the bulk density of the support layer 3a or 3b, in particular the foam layer, is concerned, this can be 5 to 250 kg/m³, in particular 10 to 150 kg/m³, preferably 20 to 100 kg/m³, more preferably 25 to 95 kg/m³.

As far as the support layer 3a or 3b is concerned, this can be in this case, as described above, a foam layer or a layer made of a foamed material. The foam material used in this respect can have a tensile strength in the transverse and/or longitudinal direction as specified in ISO 1926 of 100 to 1500 kPa, in particular 150 to 1.300 kPa, preferably 100 to 1.100 kPa; in other words the material of the support layer 3a or 3b, in particular the foam material, should have a tensile strength as specified in the abovementioned standard in the longitudinal and/or transverse direction of at least 100 kPa, in particular at least 150 kPa, preferably at least 200 kPa.

In addition, the foam material for the support layer 3a or 3b should have an elongation at break in the longitudinal or transverse direction as specified in ISO 1926 of 50 to 350%, in particular 65 to 325%, preferably 80 to 300%; in other words, the foam material for the support layer 3a or 3b should thus have an elongation at break as specified in the abovementioned standard in the longitudinal or transverse direction of at least 50%, in particular at least 65%, preferably at least 80%. As far as the compressive strength as specified in ISO 844 of the foam material for the support layer 3a or 3b is concerned, this, for a compression of 10%, should be at least 5 kPa, in particular at least 10 kPa, preferably at least 15 kPa, for a compression of 25% at least 25 kPa, in particular at least 30 kPa, preferably at least 35 kPa, for a compression of 50% at least 85 kPa, in particular at least 90 kPa, preferably at least 95 kPa. As far as the compressive deformation resistance as specified in ISO 1856/C for a load of 22 hours and a compression of 25% at 23° C. is concerned, the foam material of the support layer 3a or 3b 0.5 hours after release should have a compressive deformation resistance of at most 30%, in particular at most 25%, preferably at most 20%, and 24 hours after release, a value of at most 20%, in particular at most 15%, preferably at most 10%. Finally, the foam material for the support layer 3a or 3b should have a μ value as specified in ISO 1663 at 0 to 85% relative humidity and 23° C. of 3.000 to 20.000, in particular 3.500 to 19.000, preferably 4.000 to 18.000.

Preferably according to the invention, for the support layer 3a or 3b, use can be made of the foams from Alveo AG, Lucerne, Switzerland, marketed under the tradenames Alveolit® and Alveolen® which are particularly suitable for thermoforming, and in particular for vacuum forming (i.e. vacuum-thermoforming).

As far as the cavity 4 enclosed or fashioned by the first formed part 2a and the second formed part 2b is concerned, it can be provided that it is partially or at least essentially completely filled with at least one fluid or solid filling 9 (FIG. 2E to FIG. 2G). In this context, the filling 9 can be a fluid, in particular a gel, such as a low-viscosity, medium-viscosity or high-viscosity gel, or else a solid substance, such as a foam. The foam used for filling the cavity 4 can be, in particular, a polystyrene, polyurethane or polyolefin foam or a multicomponent foam. In this respect, in addition to the abovementioned closed-pore foams, open-pore foams also come into consideration. The cavity 4 can be completely or partially filled, for example, as described hereinafter in the context of the inventive process, during production of the inventive structural unit 1 or after its completion, in which case the filling 9 is preferably introduced into the cavity 4 through the abovementioned breakthroughs, channels or the like, in particular in the region of the interruptions of the connection ridges fashioned between the first formed part 2a and the second formed part 2b. In addition the filling 9 can also be introduced into the cavity 4 through subsequently made orifices which are introduced into the wall of the inventive structural unit 1, for example, by means of bore holes or the like.

As far as the fillings 9 in solid form which can be used according to the invention are concerned, such as the abovementioned foams, these can be introduced into the cavity 4, for example, in liquid, non-crosslinked form, with crosslinking or hardening, if appropriate including foaming, taking place in the cavity 4 itself. For this, e.g. multi-component foams come into consideration. However, it is also equally possible that the solid fillings 9 are introduced into the cavity 4 in comminuted form, for example in the form of foam beads. By filling the cavity 4, in particular a reduction of the compressibility of the inventive structural unit 1 per se is achieved, with, on account of the inherent elasticity of the materials used, an optimized ergonomic adaptation, for example to the user of seating furniture, being achieved, so that, for example, when the inventive structural unit 1 is used as seat and/or back part in the context of seating furniture, improved adaptation to the body shape results.

In addition, the fillings 9 used should be selected in such a manner that on release of the inventive structural unit 1 from force (e.g. “standing”) this is able to adopt at least essentially its original shape or structure.

The inventive structural unit 1 is in other words a structural unit 1 which is produced by forming, in particular thermoforming, preferably twin-sheet thermoforming, a first, at least essentially sheet-type, material part 8a to give a formed part 2a as defined above, and a second, at least essentially sheet-type, material part 8b to give a formed part 2b as defined above. The formed parts 2a and 2b are bonded to one another in such a manner that they fashion at least one cavity 4. As described above, the at least essentially sheet-type material parts 8a, 8b are to an extent the starting materials for producing the three-dimensional formed parts 2a and 2b which in turn are joined to give the inventive structural unit 1. In this case the inventively used material parts 8a and 8b have in particular the same structure 5a, 5b as the respective formed parts 2a and 2b produced therefrom. It is within the scope of the present invention when the material parts 8a and 8b have in each case layer structures or materials different from one another. As mentioned above, in the context of the present invention thus use is made of already at least essentially finished material parts 8a and 8b containing all components or layers and which are formed as such to give respective formed parts 2a and 2b from which the inventive structural unit 1 is produced. Subsequent application of additional layers is thus avoided completely according to the invention and the material parts 8a, 8b are thus “only” changed with respect to their shape and structure.

As far as the inventive structural unit is concerned, this is to an extent in a final form suitable for the respective application and can thus be used directly for furnishing articles, such as furniture (e.g. seating furniture), decorative elements, cavity channels and the like, for example as a formed element of a bottom side or rear side of a seat or back part or as a complete seat shell of an article of seating furniture. For this the inventive structural unit can be additionally fitted with static elements (i.e. supports, holders, connection elements, rods, chair legs etc.). In this respect after forming has been carried out, holding points or fixing points for the abovementioned elements 11 can be introduced, for example by means of bore holes.

In addition, the present invention, according to a second aspect of the present invention, relates to the use of the inventive structural unit, in particular as defined above, for production of furnishing articles, such as furniture, in particular seating furniture, decorative elements, such as partitions and the like, cavity channels and the like. Particularly preferably, the inventive structural unit can be used for seating furniture and the like, in which case the term “seating furniture” is to have a very broad meaning and relates to seating facilities or seating elements of all types, such as, for example and not by way of restriction, benches, chairs, armchairs, sofas, three-piece suites, stools and the like. The seating furniture can be designed such that it consists of an inventive structural unit or has at least one inventive structural unit. In principle, the furnishing articles can be used for purposes of an indoor arrangement to an extent as interior, and also for purposes of an outdoor arrangement to an extent as exterior.

According to the invention the structural unit can form certain units or elements of the seating furniture, such as for example a one-piece seat/back part (“seat shell”). Alternatively, in each case two different structural units can be used for a seat part or a back part of an article of seating furniture. Preferably, the design of the inventive structural unit is, for example, such that the formed part of the inventive structural unit fashioning the front side of the seat or back part preferably has a two-layered structure having an in particular flat textile material and a support layer of a foam, whereas the formed part of the structural unit fashioning the back side of the seat/back part preferably has a three-layer structure having a solid thermoplastic support and a support layer laminated thereto and also having a flat material laminated to the support layer. This makes possible a targeted and purpose-orientated differentiated combination of ergonomic properties and stability properties (front side comfortable, back side stable). According to the invention the term “front side” means the side of the seating furniture facing the user of the seating furniture, while the term “back side” relates to the side facing away from the user in the use state of the seating furniture.

In addition, use can also be made of the inventive structural unit, for example, for saddles and the like, in particular since the inventive structural unit can have intense bends or shaped regions, so that the saddles produced from the inventive structural unit can be matched exactly to the anatomy of the user. A further field of application of the inventive structural unit is, for example, its use for seating furniture in public transport, since the above-described specific layer structure having the flat lamination results in high protective resistance, since soiling cannot penetrate deeply into the material, and secondly the fixed adhesion of the individual layers results in high protective function against destruction, for example by vandalism, since the flat laminated, in particular flat textile, material is to an extent stabilized by the underlying layer, so that as a result it has a certain cutting resistance or resisting force, e.g. to puncture.

In addition, the inventive structural unit can be used as decorative element or in the form of cavity channels, such as cable cladding, covers and the like.

According to a further third aspect of the present invention, the present invention equally relates to furnishing articles, such as furniture, decorative elements, cavity channels and the like, and preferably seating furniture which have at least one inventive structural unit or consist thereof. Owing to the specific structure of the inventive structural unit, with respect to the furnishing articles, in particular furniture, such as seating furniture, it can assume not only bearing, supporting and mechanical functions, but also surface-forming optical properties. The inventive furnishing articles, in particular furniture, such as seating furniture, have, compared with the prior art, a significantly fewer number of individual components, which in turn can be fabricated using fewer working steps and low tool costs.

In this case the inventive structural unit used for the furnishing articles, in particular furniture, such as seating furniture, can be fashioned in such a manner that at its edge, for example, an indentation or recess results for accommodating a support element, which can be, for example, an appropriately curved steel tube.

Finally, the present invention further relates, according to a fourth aspect of the present invention, to a process for production of a structural unit 1, in particular as defined above, in which a first, at least essentially sheet-type, material part 8a having a support layer 3a is formed to give a first formed part 2a and a second, at least essentially sheet-type, material part 8b having a support layer 3b is formed to give a second formed part 2b. The forming proceeds in particular by means of thermoforming processes and particularly preferably using the above-described twin-sheet forming process. In this case the first formed part 2a and the second formed part 2b are bonded to one another in such a manner that the formed parts 2a and 2b fashion at least one cavity 4. The inventive process is distinguished in that the support layer 3a of the first material part 8a before and/or during the process step of forming is furnished with a flat, in particular textile, material 6a, the flat material 6a before the process step of forming, or else during the process step of forming, being laminated to the support layer 3a. In addition, the formed parts 2a and 2b are bonded to one another in such a manner that the flat material 6a is arranged on the side facing away from the cavity 4. As far as the material part 8a or 8b used according to the invention is concerned, this is in other words a thermoplastic semimanufactured product which already contains all components of the formed parts 2a, 2b. With respect to the structure 5a, 5b of the material part 8a or 8b of the first formed part 2a and also of the second formed part 2b and also of the inventive structural unit 1, reference can be made to the above statements which apply mutatis mutandis to the inventive process.

According to the invention it is thus possible to fashion the layer structure or the layer composite of the material parts 8a, 8b before forming to give the formed parts 2a, 2b, or else during the forming, i.e. the respective layers 6a, 6b; 3a, 3b; 7a, 7b of the material parts 8a, 8b are, in the latter case during forming, bonded to one another, in particular in a two-dimensional manner, preferably laminated. Here the expressions “on forming” and “during forming” are used synonymously in the context of the present invention.

Thus the flat material 6a, 6b according to an embodiment of the inventive process can be laminated during forming to the support layer 3a, 3b or the support 7a, 7b, or the flat material 6a, 6b can be laminated to the support 7a, 7b. As a result, the flat material 6a, 6b on forming is to an extent freely movable with respect to the support layer 3a, 3b or the support 7a, 7b, or the support layer 3a, 3b is in itself freely movable with respect to the support 7a, 7b at its surface and thus so to speak slidable on the support 7a, 7b, so that the respective layers can shift over one another. In this case it is in the scope of the present invention when the respective layers 6a, 6b; 3a, 3b; 7a, 7b of the material parts 8a, 8b are bonded to one another, in particular pre-laminated, at few points via individual, in particular circular or point-form, fixing sections, in order to prevent delamination before forming.

This is because it has been completely surprisingly found that particularly good forming results can be achieved when, during the shaping process or forming, the individual layers 6a, 6b; 3a, 3b of the material parts 8a, 8b are to an extent freely movable and thus so to speak freely shiftable on the support 7a, 7b of the material parts 8a, 8b, so that the respective layers can slide over one another. This is because as a result during the forming “continued flowing” or “continued sliding” of the flat material 6a, 6b or of the support layer 3a, 3b is enabled, which prevents individual layers, in particular the flat material 6a, 6b and/or the support layer 3a, 3b, being exposed on forming to excessive loading by extension and/or compression. In this manner, fold formation, delamination and/or crack formation or tearing are counteracted.

In addition it is within the scope of the present invention when the entire layer composite 2 or else individual layers are bonded to one another during forming. In this respect the layers can be charged in advance with a laminating or film-coating agent. Equally, individual layers can already be bonded to one another before forming, in particular by lamination (e.g. flat material 6a, 6b and support layer 3a, 3b or support layer 3a, 3b and support 7a, 7b). On forming the laminates are then permanently fixed to the remaining layer, in particular laminated.

According to a further embodiment, the support 7a, 7b, the flat material 6a, 6b and if appropriate the support layer 3a, 3b can be laminated at least in part before carrying out forming, in particular during forming the forming temperature being selected in such a manner that in the case of lamination using a laminating or film-coating agent the laminating or film-coating agent, in particular the adhesive, preferably hot-melt adhesive, particularly preferably the hot-melt adhesive web, is brought into a liquid, in particular viscous state, or into a thermally adhesive state. Alternatively, in the case of lamination without laminating or film-coating agent, at least one surface of the support 7a, 7b and/or the flat textile material 6a, 6b and/or the support layer 3a, 3b can become thermally adhesive, so that on forming the layers 6a, 6b; 3a, 3b; 7a, 7b can shift against one another. This is because in this inventive embodiment also, the individual layers, in particular the flat material 6a, 6b and/or the support layer 3a, 3b are to an extent freely movable with respect to the support 7a, 7b on forming and thus so to speak freely shiftable on the support 7a, 7b, so that during forming “continued flowing” or “continued sliding” of the flat material 6a, 6b or the support layer 3a, 3b is enabled and fold formation, delamination or tearing are counteracted.

In addition it was completely surprisingly found that, using a material part 8a, 8b, in which the flat material 6a, 6b and/or the support layer 3a, 3b is or are dimensioned smaller in area terms than the support 7a, 7b, so that the support 7a, 7b to an extent extends over at least one edge of the flat material 6a, 6b and/or the support 7a, 7b, particularly good forming properties result. Customarily, for purposes of forming the material parts 8a, 8b, use is made of a frame or part moulds 10a, 10b known per se for purposes of forming to those skilled in the art for receiving the material parts 8a, 8b, the material parts 8a, 8b being fixed or clamped in particular at their rim regions by the frame or part moulds 10a, 10b. Surprisingly, it has now been found that particularly good results with respect to forming the material parts 8a, 8b can be achieved when the flat material 6a, 6b and/or the support layer 3a, 3b is not gripped or fixed by the part moulds 10a, 10b. This can be achieved firstly by the smaller dimensioning of the flat material 6a, 6b and/or the support layer 3a, 3b compared with the support 7a, 7b, or else by the above-described non-lamination of the rim regions of the layer structure or layer composite or by a low compression force with respect to the material part 8a, 8b. As a result of the non-gripping of the rim regions of the flat material 6a, 6b and/or the support layer 3a, 3b, during the forming of the material part 1 a particularly good “continued flowing” or “continued sliding” of the flat material 6a, 6b and/or the support layer 3a, 3b is achieved.

FIG. 2 illustrates diagrammatically the sequence of the individual process steps of the inventive process: FIG. 2A shows the sheet-type material parts 8a, 8b used which to an extent act as starting material for production of the inventive structural unit 1. In this case the first material part 8a has a two-layer structure 5a having a support layer 3a and a flat material 6a associated to this, while the second sheet-type material part 8b has a three-layer structure 5b which comprises an in particular thermoplastic support 7b, a support layer 3b applied to the support 7b and a flat material 6b applied to the support layer 3b. In addition, however, other layer structures different from this embodiment are also possible, in particular as defined above.

As stated above, the inventive process is preferably carried out using what is termed the twin-sheet process. A characteristic of the twin-sheet process is the possibility of forming two in particular thermoplastic, sheet-type starting materials to a certain extent in a single working step simultaneously in each case to give shaped bodies, and of bonding these simultaneously to one another in such a manner that a cavity 4 results, the twin-sheet process leading to an essentially complete structural unit 1 which is then available for uses of the abovementioned type.

As far as matching the twin-sheet process to the inventively used material parts 8a, 8b is concerned, those skilled in the art are always able to select the respective parameters appropriately and adapt these appropriately with respect to the material parts 8a, 8b to be formed and with respect to the resultant structural unit 1.

The inventive process is distinguished in that the flat material 6a, 6b is laminated to the support layer 3a, 3b before or during carrying out the process steps of forming the material parts 8a and 8b to give the formed parts 2a and 2b, respectively, and their being joined to give the inventive structural unit 1. In other words, thus an at least essentially prefabricated material 8a or 8b having layer structure 5a or 5b is subjected to a subsequent forming procedure or process. Thus the material part 8a or 8b used for forming, in particular twin-sheet forming, already possesses all of the layers of the inventive structural unit 1 resulting therefrom. The twin-sheet process therefore to an extent essentially “only” changes the shape or structure of the material parts 8a and 8b and joins these to one another in such a manner that a cavity body 1 results, or the layer structure of the material parts 8a, 8b is strengthened by bonding, in particular laminating, the corresponding layers 6a, 6b; 3a, 3b; 7a, 7b. By means of this special measure it is actually possible to produce intense bends with respect to the resultant structural unit 1 without delamination and without fold formation of the flat material 6a or 6b or of the support layer 3a or 3b.

FIG. 2B shows the introduction of the material parts 8a and 8b which are at least essentially arranged in parallel and slightly spaced from one another into a mould consisting of two part moulds 10a and 10b, the part moulds 10a, 10b being able to be fashioned as positive or negative moulds and, for the purposes of the following forming or joining, the material parts 8a and 8b being heated jointly or independently of one another to a temperature above the softening point of the support layers 3a and 3b and/or the support 7a or 7b, respectively. The heating can be performed, for example, by means of hot air, radiant heater, such as infrared radiator, and the like. In addition, it is possible to carry out the heating before and/or during the forming to give the structural unit 1. FIG. 2B further illustrates that the material parts 8a and 8b are brought into contact with the respective part moulds 10a and 10b in such a manner that the material parts 8a and 8b abut at least essentially air-tightly, in particular at their rim regions and/or ridges of the respective part moulds 10a and 10b. These regions subsequently form to an extent the ridges or connection points of the formed parts 2a and 2b bonded to give the inventive structural unit 1. If the structural unit 1 according to the invention has a plurality of cavities 4, the ridges can also proceed, for example, in central regions of the material parts 8a and 8b or of the resultant formed parts 2a and 2b.

FIG. 2C shows in addition that between at least one of the material parts 8a and 8b and at least one of the part moulds 10a and 10b vacuum is admitted. This results in the fact that at least one of the material parts 8a and 8b abuts at least one of the part moulds 10a and 10b, i.e. in other words at least one of the material parts 8a and 8b is formed to give a formed part 2a or 2b having three-dimensional shape or structure. According to the invention, preferably, both material parts 8a and 8b are formed to give respective three-dimensional formed parts 2a and 2b, in which case the forming of the shape can be carried out simultaneously or subsequently. As FIG. 2C equally shows, it is possible that between the first material part 8a and the second material part 8b pressurization, preferably by means of air, is carried out. As a consequence of the pressurization, the material parts 8a and 8b are separated from one another and to an extent forced into the part moulds 10a, 10b for fashioning the formed parts 2a, 2b. The optional process step of pressurization can be carried out simultaneously with the vacuum admission or else independently of this. Thus it is possible according to the invention to carry out the forming either by vacuum charging or by increased pressurization or their combination.

As FIG. 2D shows, the material parts 8a and 8b which are transformed to the respective formed parts 2a and 2b at least essentially completely abut the part moulds 10a and 10b, respectively; subsequent or simultaneous pressing together of the part moulds 10a and 10b bond the formed parts 2a and 2b to one another in particular in sections to produce the inventive structural unit 1. As a consequence, a cavity 4 enclosed by the formed parts 2a and 2b results. The formed parts 2a and 2b can equally be bonded by means of lamination or film-coating, in particular by means of adhesion, or owing to the thermal adhesiveness of the formed parts 2a and 2b. The connection sites of the formed parts are preferably fashioned as ridge-type, in particular at the rim regions of the part moulds 2a and 2b. Adhesives which come into consideration are the abovementioned adhesives.

According to the invention, the flat, in particular textile, materials 6a, 6b are situated in each case on the outside of the structural unit 1 of the invention produced by means of the inventive process.

As FIG. 2E further shows, it is possible to fill the cavity 4 with the fillings 9 described above, which can be performed during or after the forming or bonding of the formed parts 2a and 2b.

Subsequently, the structural unit 1 is cooled preferably in the mould to temperatures below the softening point. Subsequently the structural unit 1 is removed from the mould as shown in FIG. 2F. In this respect, it can be provided that for improved detachment of the structural unit 1 from the part moulds 10a and 10b, a pressurization, preferably by means of air, is carried out between the part moulds 10a and 10b and the structural unit 1.

Finally, it can be provided that the material parts 8a and 8b and/or the structural unit 1 are additionally furnished with at least one static or decorative element 11, for example a profiled strip, or else a rod or the like, as shown in FIG. 2G. The element 11 can act, for example, for receiving further elements (such as for example racks, chair legs and the like) or be designed as such.

In other words the present invention thus relates to a process for production of a structural unit 1, in particular for production of furniture, decorative elements, cavity channels and the like, in which a first material part 8a, as defined above, and a second material part 8b, as defined above, are formed by forming processes known per se, in particular thermoforming, preferably twin-sheet thermoforming, to form an inventive structural unit 1 as defined above.

Thus, the present invention also relates to a process for the production of a structural unit as defined above, in which a first, at least essentially sheet-type, material part 8a having a support layer 3a is formed, in particular thermoformed, to give a first formed part 2a and a second, at least essentially sheet-type, material part 8b having a support layer 3b is formed, in particular thermoformed, to give a second formed part 2b, and the first formed part 2a and the second formed part 2b are bonded to one another in such a manner that the formed parts 2a, 2b fashion at least one cavity 4, said process being characterized that the support layer 3a of the first material part 8a before and/or during the process step of forming is furnished with a flat, in particular textile, material 6a, the flat material 6a before the process step of forming, or else during the process step of forming, being laminated to the support layer 3a, and in that the formed parts 2a, 2b are bonded to one another in such a manner, in particular bonded in sections, that the flat material 6a is arranged on the side facing away from the cavity 4.

An in particular thermoplastic support 7a, in particular as defined above, may be applied to the support layer 3a of the material part 8a before and/or during the process step of forming, in particular the support 7a being bonded, in particular in a two-dimensional manner, to the support layer 3a, preferably on the side facing the cavity 4.

The flat material 6a and/or the support 7a is/are laminated to the support layer 3a, in particular in a two-dimensional manner, during the process step of forming.

The flat material 6a and/or the support 7a is/are laminated to the support layer 3a, in particular in a two-dimensional manner, by means of a laminating or film-coating agent, in particular an adhesive, preferably a hot-melt adhesive.

The support layer 3a, the flat material 6a and optionally the support 7a are laminated at least in part before the process step of forming, in particular during forming, the forming temperature being selected in such a manner that in the case of lamination using a laminating or film-coating agent the laminating or film-coating agent, in particular the adhesive, preferably hot-melt adhesive, particularly preferably the hot-melt adhesive web, is brought into a liquid, in particular viscous, and/or thermally adhesive state and/or alternatively in the case of lamination without laminating or film-coating agent, at least one surface of the support layer 3a and/or the flat material 6a and/or if appropriate the support 7a becomes thermally adhesive, so that in the process step of forming, the layers 3a, 6a, 7a can shift against one another.

The material part 8b is furnished with a multilayered structure 5b, in particular before and/or during the process step of forming a flat, in particular textile, material 6b being associated to the support layer 3b, the flat material 6b before and/or during the process step of forming being laminated to the support layer 3b on the side of the support layer 3b facing away from the cavity 4.

The material part 8b before and/or during the process step of forming is furnished with an in particular thermoplastic support 7b, in particular as defined above; in particular the support (7b) before and/or during the process step of forming is bonded, in particular in a two-dimensional manner, to the support layer 3b, preferably on the side facing the cavity 4.

The flat material 6b and/or the support 7b is/are laminated to the support layer 3b, in particular in a two-dimensional manner, during the process step of forming.

The flat material 6b and/or the support 7b may be laminated to the support layer 3b, in particular in a two-dimensional manner, by means of a laminating or film-coating agent, in particular an adhesive, preferably a hot-melt adhesive.

The support layer 3b, the flat material 6b and if appropriate the support 7b may be laminated at least in part before the process step of forming, in particular during forming, the forming temperature being selected in such a manner that in the case of lamination using a laminating or film-coating agent the laminating or film-coating agent, in particular the adhesive, preferably hot-melt adhesive, particularly preferably the hot-melt adhesive web, is brought into a liquid, in particular viscous, and/or thermally adhesive state and/or wherein in the case of lamination without laminating or film-coating agent, at least one surface of the support layer 3b and/or the flat material 6b and/or if appropriate the support 7a becomes thermally adhesive, so that in the process step of forming, the layers 3b, 6b, 7b can shift against one another.

The material parts 8a, 8b may be heated jointly or independently of one another to a temperature above the softening point of the support layers 3a, 3b and/or the support 7a, 7b.

The material parts 8a, 8b are transferred, preferably in a parallel orientation, into a mould preferably consisting of two part moulds 10a, 10b.

The material parts 8a, 8b are brought into contact with the part moulds 10a, 10b in such a manner that the material parts 8a, 8b abut at least essentially air-tightly at rim regions and/or ridges of the part moulds 10a, 10b.

Between at least one of the material parts 8a, 8b and at least one of the part moulds 10a, 10b vacuum is admitted so that at least one of the material parts 8a, 8b is formed onto at least one of the part moulds 10a, 10b, in particular at least one of the material parts 8a, 8b being formed in such a manner that at least one resulting formed part 2a, 2b, preferably both formed parts 2a, 2b, has or have a three-dimensional shape or structure.

Between the first material part 8a and the second material part 8b pressurization, preferably by means of air, is carried out, in particular the material parts 8a, 8b being separated from one another and forced into the part moulds 10a, 10b.

The formed parts 2a, 2b for producing the structural unit 1 are in particular bonded to one another in sections, in particular the cavity 4 being enclosed by the formed parts 2a, 2b.

The structural unit 1 is cooled preferably in the mould to temperatures below the softening point of the support layer 3a, 3b and/or the support 7a, 7b and is subsequently removed from the mould.

After production of the structural unit 1 and cooling of the structural unit 1 to temperatures below the softening point of the support layer 3a, 3b, between the structural unit 1 and the part moulds 10a, 10b pressurization, preferably by means of air, is carried out.

The cavity 4, during or after production of the structural unit 1, is partially or at least essentially completely filled with at least one filling 9, in particular as defined above.

The forming for production of the structural unit 1 may be carried out by means of thermoforming, in particular twin-sheet thermoforming.

The material parts 8a, 8b and/or the structural unit 1 may be additionally furnished with at least one static and/or decorative element 11.

Furthermore, the present invention relates to a process for production of a structural unit 1, in particular for the production of furniture, decorative elements, cavity channels and the like, said process being characterized in that a first material part 8a, as defined above, and a second material part 8b, as defined above, are formed by forming processes known per se, in particular thermoforming, preferably twin-sheet thermoforming, to form a structural unit as defined above.

Further inventively preferred embodiments of the inventive process for production of the structural unit 1 of the invention are subject-matter of the process subclaims.

The inventive structural unit and also furnishing articles produced therefrom, such as furniture, and also the process for production of the inventive structural unit have numerous advantages of which the following shall be mentioned purely by way of example:
On account of the special layer structure in which the two formed parts fashioning the structural unit can be made different from one another, self-supporting or load-bearing shapes and structures of high ergonomic adaptability can be created. By using a thermoplastic and preferably solid support, the inventive structural unit has a high stability, so that it is usable for numerous applications, for example for use in or as seating furniture. In addition, as a result of the special design of the other formed part, for example having a flexible foam and a flat material applied thereon, high flexibility and adaptability to anatomical structures can be achieved, in particular when the cavity is additionally filled with a further foam material.
As a result of the individual design of the individual layers, high variation and selection of the respective product properties is possible, with simultaneously high attractiveness and individual configurability of the surface (material covering).
On account of the inventive principle according to which the flat, in particular textile, material is laminated to the support layer before the forming or during the forming, a product which is to an extent finished is subjected to the actual forming process, as a result of which highly pronounced forming and consequently individualized configuration of the structural unit can be achieved, without adverse appearances such as delamination and fold formation occurring.
In addition numerous different shapes and structures can be achieved, so that the inventive structural unit can be used in broad fields.
Fashioning the layer structure even before or during the forming makes possible complete bonding of all layers in the finished structural unit, which cannot be achieved with subsequent lamination in the region of intense bulges and bends.
The resultant structural units are to a great extent resistant to soiling and damage, so that they are suitable, in particular, for use in or as seating units, e.g. in public transport.
Production of the inventive structural unit comprises a small number of process steps with minimized tool use, so that this is an extremely inexpensive production process.
Using the inventive process, complete units of a piece of furniture, for example a seat part/back part of an article of seating furniture, can be produced with a small number of working steps to obtain the desired final shape.
By means of the optionally provided, solid thermoplastic support, the inventive structural unit, after forming, has self-supporting functions, which gives it high importance in particular with respect to seating systems.
Since during the forming of the material parts, between the material parts at least one cavity is produced, this can be filled with one or more foams having specific properties, as a result of which the properties of the resultant structural unit can be further optimized.
According to the invention it is possible to equip the material parts before or during the forming step, e.g. with an additional static traverse frame for receiving, for example, chair legs or the like or with dependent functional elements (for example between a seat part and back part).
The connection sites or edges due to processing, which result from connection of the formed parts, can be used to support construction, e.g. for reception in a positive-locking seat frame profile meeting the requirements.

Further embodiments, modifications and variations of the present invention can be recognized without problems by those skilled in the art on reading the description and can be achieved without departing from the context of the present invention.

The present invention will be illustrated by the following Example, which is, however, not limiting wit respect to the present invention.

### INVENTIVE EXAMPLE

For production of a seat part and/or back part of an article of seating furniture, a thermoformable foam of a sheet-type material part is equipped with a textile surface. In addition, a second sheet-type material part which is the lower side of the seat part and/or back part is equipped with a textile surface, a thermoformable foam and a solid thermoplastic support and in each case heated to the corresponding forming temperature.

Subsequently the material parts are positioned between an upper side mould and a lower side mould for the seat part and/or back part. Subsequently, by means of vacuum between the moulds on the one hand and the material parts on the other and overpressure between the material parts, the material parts of the top side and the lower side are brought into the final shape of the seat part and/or back part.

In a subsequent working step, the cavities of the seat part and/or back part resulting between the material parts and formed parts are filled. For this, use can be made of a multicomponent foam, for example.

After removing the final shape of the seat part and/or back part from the top side mould and the bottom side mould, a traverse profile is attached to the edge of the seat part and/or back part representing the connection between the material parts. The resultant seat part and/or back part can be bonded, for example, to a rack construction to obtain an article of seating furniture.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A structural unit, the structural unit being appropriate for the production of furniture, decorative elements, cavity channels and the like and the structural unit comprising a first formed part having a first support layer and a second formed part having a second support layer, the first formed part and the second formed part fashioning at least one cavity, wherein the first formed part has a multilayered structure comprising a flat material associated to the first support layer, the flat material being laminated to the first support layer on the side of the first support layer facing away from the cavity.

2. The structural unit according to claim 1, wherein at least one of the formed parts has a three-dimensional shape or structure.

3. The structural unit according to claim 1, wherein the formed parts are bonded to one another in sections.

4. The structural unit according to claim 1, wherein the first formed part additionally has a thermoplastic support, the thermoplastic support being bonded to the first support layer on the side facing the cavity.

5. The structural unit according to claim 1, wherein the second formed part also has a multilayered structure comprising a flat material associated to the second support layer, the flat material being laminated to the second support layer on the side of the second support layer facing away from the cavity, and wherein the second formed part additionally has a thermoplastic support, the thermoplastic support being bonded to the second support layer on the side facing the cavity.

6. The structural unit according to claim 1, wherein the flat material is a textile material which is reversibly extensible and has an extensibility in at least one direction of at least 5%.

7. The structural unit according to claim 1, wherein flat material is laminated to the first support layer by means of a laminating or film-coating agent.

8. The structural unit according to claim 1, wherein the first and/or second support layer is a closed-pore or closed-cell thermoplastic foam based on polyolefins or polyurethanes.

9. The structural unit according to claim 1, wherein the first and/or second support layer is a thermoplastic which is hard at room temperature (25° C.) and atmospheric pressure and is dimensionally stable and self-supporting.

10. The structural unit according to claim 1, wherein the cavity is partially or completely filled with at least one fluid or solid filling, the filling being selected from the group consisting of gels and foams.

11. A structural unit which is appropriate for the production of furniture, decorative elements, cavity channels and the like and produced by twin-sheet thermoforming a first sheet-type material part to give a first formed part and a second sheet-type material part to give a second formed part, the formed parts being bonded to one another in such a manner and in sections so that the formed parts fashion at least one cavity.

12. A structural unit being appropriate for the production of furniture, decorative elements, cavity channels and the like, the structural unit having a three-dimensional shape or structure and comprising a first formed part having a first support layer and a second formed part having a second support layer the first formed part and the second formed part fashioning at least one cavity, the first formed part having a multilayered structure comprising a flat textile material associated to the first support layer, the flat textile material being laminated to the first support layer on the side of the first support layer facing away from the cavity.

13. A process for production of a structural unit according to one of claims 1 to 12, wherein a first sheet-type material part having a first support layer is formed to give a first formed part and wherein a second sheet-type material part having a second support layer is formed to give a second formed part, the first formed part and the second formed part being bonded to one another in such a manner that the formed parts fashion at least one cavity, wherein the first support layer of the first material part, before and/or during the process step of forming, is furnished with a flat textile material, the flat textile material, before the process step of forming or else during the process step of forming, being laminated to the first support layer, and wherein the formed parts are bonded to one another in such a manner in sections so that the flat textile material is arranged on the side facing away from the cavity.

14. The process according to claim 13, wherein a thermoplastic support is applied to the first support layer of the first material part before and/or during the process step of forming, the thermoplastic support being bonded to the first support layer on the side facing the cavity.

15. The process according to claim 14, wherein the flat material and/or the thermoplastic support is/are laminated to the first support layer during the process step of forming.

16. The process according to claim 14, wherein the first support layer, the flat material and optionally the thermoplastic support are laminated at least in part before the process step of forming, wherein, during forming, the forming temperature is selected in such a manner that in the case of lamination using a laminating or film-coating agent the laminating or film-coating agent is brought into a liquid state, so that in the process step of forming, the layers can shift against one another.

17. The process according to claim 14, wherein the first support layer, the flat material and optionally the thermoplastic support are laminated at least in part before the process step of forming, wherein, during forming, the forming temperature is selected in such a manner that in the case of lamination without laminating or film-coating agent, at least one surface of the first support layer and/or the flat material and/or if present the thermoplastic support becomes thermally adhesive, so that in the process step of forming, the layers can shift against one another.

18. The process according to claim 13, wherein the second material part is furnished with a multilayered structure before and/or during the process step of forming, with a flat textile material being associated to the second support layer, the flat material before and/or during the process step of forming being laminated to the second support layer on the side of the second support layer facing away from the cavity.

19. The process according to claim 13, wherein the second material part before and/or during the process step of forming is furnished with a thermoplastic support, with the support before and/or during the process step of forming being bonded to the second support layer on the side facing the cavity.

20. The process according to claim 13, wherein the first and second material parts are brought into contact with the part moulds in such a manner that the first and second material parts abut air-tightly at rim regions and/or ridges of the part moulds.

21. The process according to claim 13, wherein between at least one of the first or second material parts and at least one of the part moulds vacuum is admitted so that at least one of the first or second material parts is formed onto at least one of the part moulds, with at least one of the first or second material parts being formed in such a manner that at least one resulting formed part has a three-dimensional shape or structure.
